(19) United States
(12) Patent Application Publication
(10) Pub. No.: US 2018/0026986 A1
(43) Pub. Date: Jan. 25, 2018

(54) DATA LOSS PREVENTION SYSTEM AND DATA LOSS PREVENTION METHOD

(71) Applicant: Hitachi Solutions, Ltd., Tokyo (JP)

(72) Inventors: Katsumasa NANJO, Tokyo (JP); Tateki HARADA, Tokyo (JP)

(21) Appl. No.: 15/440,546

(22) Filed: Feb. 23, 2017

(30) Foreign Application Priority Data
Jul. 22, 2016 (JP) 2016-144183

(51) Int. Cl. H04L 29/06; G06F 21/60

(52) U.S. Cl. CPC H04L 63/10; H04L 63/1425; G06F 21/602

(57) ABSTRACT

A data loss prevention system holds: a first file, which is one of an unencrypted file and a file that is automatically decryptable by the processor; a second file, which is not automatically decryptable; and process information indicating an allowed process that is allowed to access a file held by the storage device. The data loss prevention system receives a file access request by the process, judges whether or not the process is the allowed process by referring to the process information, executes judgment processing for judging whether or not network communication by the process is to be prohibited, and prohibits the network communication by the process when it is judged in the judgment processing that the process is the allowed process and that a file to be accessed in the file access request is the first file.

### CLAIM OF PRIORITY

The present application claims priority from Japanese patent application JP 2016-144183 filed on Jul. 22, 2016, the content of which is hereby incorporated by reference into this application.

### BACKGROUND OF THE INVENTION

The present invention relates to a data loss prevention system and a data loss prevention method.

JP 2015-056090 A is background art relating to this technical field. In JP 2015-056090 A, there is described that “A list is prepared of applications that are not encrypted for file types to be protected, and access from an application that is not in the list is allowed after the files have been encrypted. Files that have been encrypted and then stored are automatically decrypted.” (refer to Abstract).

The technology described in JP 2015-056090 A allows a file to be accessed without the file being encrypted for a file access request by an application registered in a white list. However, in the technology described in JP 2015-056090 A, when a legitimate application registered in the white list has been infected with injection malware, for example, a worm, the legitimate application infected with the injection malware may illegitimately steal an unencrypted file via a network.

In the technology described in JP 2015-056090 A, when none of the applications performing network communication are registered in the white list, the illegitimate stealing of an unencrypted file by a legitimate application that has been infected with injection malware can be prevented.

However, in order to remove all of the applications performing network communication from the white list, the user needs to know which applications perform network communication. Therefore, the level of security may depend on knowledge of the user, and user convenience regarding white list registration may be impaired.

### SUMMARY OF THE INVENTION

Therefore, it is an object of one mode of this invention to prevent, even when file access by a process performing network communication is allowed, illegitimate stealing of a file that is not encrypted or that can be automatically decrypted.

One mode of the present invention has the following configuration to solve above-mentioned problem. A data loss prevention system which is configured to control network communication and to control access to a file by a process, the data loss prevention system comprising: a processor; and a storage device, the storage device being configured to hold: a first file, which is one of an unencrypted file and a file that is automatically decryptable by the processor; a second file, which is not automatically decryptable by the processor; and process information indicating an allowed process that is allowed to access a file held by the storage device, the processor being configured to: receive a file access request by the process; judge whether or not the process is the allowed process by referring to the process information; execute judgment processing for judging whether or not network communication by the process is to be prohibited; and prohibit the network communication by the process when it is judged in the judgment processing that the process is the allowed process and that a file to be accessed in the file access request is the first file.

One mode of the present invention can prevent, even when file access by a process performing network communication is allowed, illegitimate stealing of a file that is not encrypted or that can be automatically decrypted.

The problems, configurations, and effects other than those described above become apparent by the descriptions of embodiments below.

### BRIEF DESCRIPTIONS OF DRAWINGS

The present invention can be appreciated by the description which follows in conjunction with the following figures, wherein:

FIG. 1A is a block diagram for illustrating a configuration example of a data loss prevention system according to the first embodiment;

FIG. 1B is a block diagram for illustrating a hardware configuration example of a client according to the first embodiment;

FIG. 2 is an explanatory diagram for illustrating an example of file access control and data transmission control according to the first embodiment;

FIG. 3 is an example of a process list according to the first embodiment;

FIG. 4 is a flowchart for illustrating an example of process activation processing according to the first embodiment;

FIG. 5 is a flowchart for illustrating an example of processing performed when logging on to an OS according to the first embodiment;

FIG. 6 is a flowchart for illustrating an example of processing performed when a process has ended according to the first embodiment;

FIG. 7 is a flowchart for illustrating an example of file access control processing according to the first embodiment;

FIG. 8 is a flowchart for illustrating an example of data transmission control processing according to the first embodiment;

FIG. 9 is an explanatory diagram for illustrating an example of white list update processing according to the first embodiment;

FIG. 10 is a flowchart for illustrating an example of processing of generating an updated application list according to the first embodiment.

### DETAILED DESCRIPTION OF THE PREFERRED EMBODIMENTS

Embodiments of this invention are described below with reference to the accompanying drawings. However, it should be noted that the embodiments described below are merely examples for realizing this invention and do not limit a technical scope of this invention. Components common across the respective drawings are denoted by the same reference symbols.

The problems to be solved by this invention, the configurations, and the advantageous effects other than those described above according to this invention are made clear based on the following description of the embodiments.

### First Embodiment

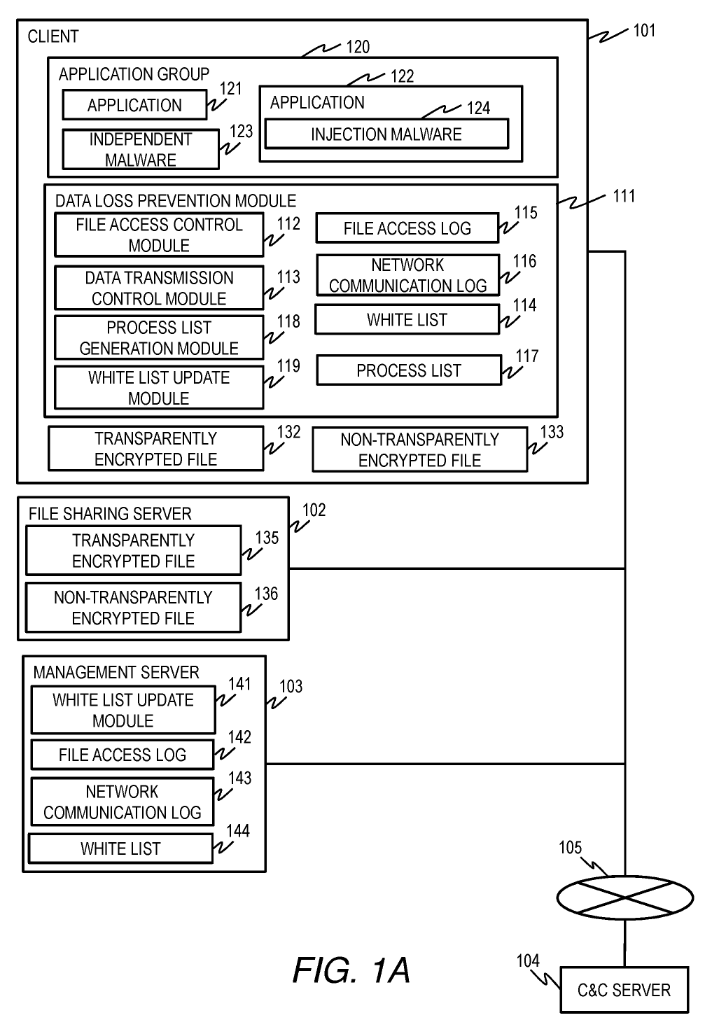

FIG. 1A is a block diagram for illustrating a configuration example of a data loss prevention system. The data loss prevention system includes, for example, a client 101, a file sharing server 102, and a management server 103. The file sharing server 102 and the management server 103 are coupled to the client 101 by a local network. The data loss prevention system is coupled to, for example, an external server via an external network, such as an Internet 105. In this embodiment, there is described an example in which a command and control (C&C) server 104 attacks the data loss prevention system via the Internet 105.

The client 101 includes a data loss prevention module 111, an application group 120, one or more transparently encrypted files 132, and one or more non-transparently encrypted files 133. The data loss prevention module 111 is configured to protect the transparently encrypted file 132 and the non-transparently encrypted file 133 stored in the client 101. The data loss prevention module 111 may also be configured to protect a transparently encrypted file 135 and a non-transparently encrypted file 136 stored in the file sharing server 102.

The transparently encrypted file is, for example, an encrypted file that can be automatically decrypted by a program stored in the data loss prevention module 111, for example. In other words, a user can refer to a transparently encrypted file without being aware that the transparently encrypted file is encoded. In this embodiment, the term “transparently encrypted file” may be a concept including a file that has not been encrypted.

The non-transparently encrypted file is a file protected by a password that is set by the user, for example, and cannot be automatically unlocked. Therefore, the non-transparently encrypted file is an encrypted file that can only be referred to by a user who has input a correct password, and cannot be automatically decrypted by the client 101. The non-transparently encrypted file is an example of an information rights management (IRM) file.

In the example of FIG. 1A, the application group 120 includes an application 121, an independent malware 123, and an application 122 which is infected with an injection malware 124. The independent malware 123 is malware such as a worm, and the independent malware 123 is capable of operating by itself without relying on another program. The injection malware 124 is malware that operates by relying on another program (in the example of FIG. 1A, the application 122).

The data loss prevention module 111 is configured to prevent malware from automatically decrypting a transparently encrypted file 132 and leaking the decrypted transparently encrypted file 132 to the C&C server 104 on the Internet 105. The data loss prevention module 111 includes a file access control module 112, a data transmission control module 113, a process list generation module 118, and a white list update module 119. Each of those modules is a program. The data loss prevention module 111 also includes a white list 114, a file access log 115, a network communication log 116, and a process list 117.

The white list 114 lists, for example, applications that are allowed to access the files. Specifically, the white list 114 stores, for example, a hash value of a module of an application that is allowed to access the files, a path of that module, and a presence/absence of a signature for that module.

The process list 117 lists whether or not an application process is an allowed process that is allowed to access the files or a prohibited process that is not allowed to access a part or all of the files. The process list 117 stores an allowance judgment criterion of network communication by the application processes. A specific example of the process list 117 is described later.

The process list generation module 118 is configured to classify the application processes into allowed processes and prohibited processes by using the white list 114. For example, the process list generation module 118 judges that the application 121 and the application 122, which are registered in the white list 114, are allowed processes, and that the independent malware 123, which is not registered in the white list 114, is a prohibited process.

The file access control module 112 is configured to control access to the files by each process by referring to the process list 117. The file access control module 112 is also configured to set the allowance judgment criterion of network communication in the process list 117. The file access control module 112 is configured to record a result of access to the files by the application processes in the file access log 115, and to transmit the file access log 115 to the management server 103.

The file access log 115 shows, for example, at least one of an access request history and an access history of the files stored in the client 101 by the applications in the application group 120. The file access log 115 includes, for example, information indicating a process that has requested access to a file, an application corresponding to that process, a user privilege that executed the application, the file, the file type (i.e., whether the file is a transparently encrypted file or a non-transparently encrypted file), the time at which access was requested, and the process type (i.e., whether the process is an allowed process or a prohibited process).

The data transmission control module 113 is configured to control network communication by the application processes. The data transmission control module 113 is also configured to record a result of network communication by processes of the application in the network communication log 116, and to transmit the network communication log 116 to the management server 103.

The network communication log 116 shows, for example, a network communication request history and/or a network communication history by the applications in the application group 120. The network communication log 116 includes, for example, information indicating a process that requested network communication, an application corresponding to that process, the process type (i.e., whether a network prohibited flag, which is described later, is ON or OFF), a file to be transmitted by the network communication, the time at which the network communication was requested, a communication protocol for the network communication, and an application that transmitted the file.

The file sharing server 102 is configured to hold one or more transparently encrypted files 135 and one or more non-transparently encrypted files 136. The client 101 and the file sharing server 102 are configured to transmit and receive files to and from each other.

The management server 103 is configured to hold a file access log 142, a network communication log 143, and a white list 144. The management server 103 also includes a white list update module 141, which is a program. The file access log 142 is a log in which the file access logs 115 received from each client 101 are accumulated.

The white list update module 141 is configured to generate the white list 144, which includes a white list for updating, by using the file access log 142 and the network communication log 143, and to transmit the generated white list for updating to each client 101. The white list update module 119 of each client 101 is configured to update the white list 114 in accordance with the received white list for updating.

FIG. 1B is a block diagram for illustrating a hardware configuration example of the client 101. The client 101 is constructed of a computer including a processor (CPU) 151, a memory 152, an auxiliary storage device 153, and a communication interface 154.

The processor 151 is configured to execute programs stored in the memory 152. The memory 152 includes a ROM being a non-volatile storage element and a RAM being a volatile storage element. The ROM stores therein an invariable program (for example, a BIOS) and the like. The RAM is a high-speed and volatile storage element, such as a dynamic random access memory (DRAM), and is configured to temporarily store therein a program to be executed by the processor 151, and data to be used in executing the program. For example, the memory 152 stores the application group 120 and the data loss prevention module 111.

The auxiliary storage device 153 is, for example, a large-scale and non-volatile storage device, such as a magnetic storage device (HDD) and a flash memory (SDD) and is configured to store therein a program to be executed by the processor 151 and data to be used in executing the program. In other words, the program is read out from the auxiliary storage device 153 to be loaded into the memory 152, and is executed by the processor 151.

For example, the auxiliary storage device 153 stores the transparently encrypted file 132 and the non-transparently encrypted file 133. In the above description, a part or all of the information stored in the auxiliary storage device 153 may be stored in the memory 152, and in the above description, a part or all of the information stored in the memory 152 may be stored in the auxiliary storage device 153.

The client 101 may also include an input interface 155 and an output interface 158. The input interface 155, which is coupled to a keyboard 156, a mouse 157, and the like, is configured to receive input from an operator. The output interface 158, which is coupled to a display apparatus 159, a printer, and the like, is configured to output an execution result of a program in a form that can be visually recognized by the operator.

The communication interface 154 is a network interface apparatus configured to control communication to and from another apparatus in accordance with a predetermined protocol. The communication interface 154 includes a serial interface, such as a universal serial bus (USB).

A program to be executed by the processor 151 is provided to the client 101 through a removable medium (such as a CD-ROM and a flash memory) or a network, and is then stored in the nonvolatile auxiliary storage device 153 being a non-transitory storage medium. Thus, it is preferred that the client 101 have an interface through which data is read from the removable medium.

The client 101 is a computer system which is physically configured on one computer or which is configured on a plurality of logical or physical computers. In addition, the computer system may be operated in separate threads on the same computer, or may be operated on a virtual computer constructed on a plurality of physical computer resources. A plurality of clients 101 may be physically configured on one computer.

For example, the processor 151 is configured to function as a file access control module by operating in accordance with the file access control module 112, which is a program loaded into the memory 152, and to function as a data transmission control module by operating in accordance with the data transmission control module 113, which is a program loaded into the memory 152. The same also applies for other programs.

The hardware configuration of the file sharing server 102 and the management server 103 is the same as the hardware configuration of the client 101, and hence a description thereof is omitted here. For example, the transparently encrypted file 135 and the non-transparently encrypted file 136 are stored in an auxiliary storage device of the file sharing server 102. The white list update module 141 is stored in, for example, a memory of the management server 103, and the file access log 142, the network communication log 143, and the white list 144 are stored in, for example, an auxiliary storage device of the management server 103. At least two from among the client 101, the file sharing server 102, and the management server 103 may be physically configured on one computer.

In this embodiment, the information to be used by each apparatus may be expressed in any kind of data structure. A data structure appropriately selected from a table, a list, a database (DB), and a queue, for example, can store the information.

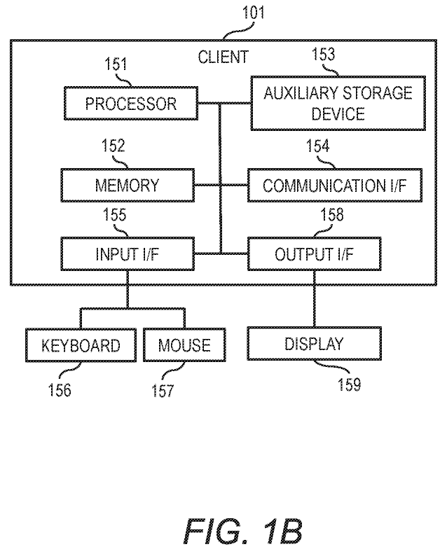

FIG. 2 is an explanatory diagram for illustrating an example of file access control and data transmission control by the data loss prevention module 111. The file access control module 112 is configured to control access to each transparently encrypted file 132 and each non-transparently encrypted file 133.

The data transmission control module 113 is configured to control network communication between the client 101 and the file sharing server 102, which is a server on a local network, and network communication between the client 101 and the C&C server 104, which is a server on the Internet 105. The data loss prevention module 111 may also be configured to execute file access control and data transmission control on each transparently encrypted file 135 and each non-transparently encrypted file 136 on the file sharing server 102.

The file access control module 112 is configured to judge whether the process of each application in the application group 120 is an allowed process or a prohibited process by referring to the white list 114. The file access control module 112 is configured to allow access to the transparently encrypted files 132 and the non-transparently encrypted files 133 by an application 211 and an application 212, which correspond to an allowed process. The file access control module 112 is also configured to prohibit access to the transparently encrypted files 132 but allow access to the non-transparently encrypted files 133 by an application 213 and an application 214, which correspond to a prohibited process.

The file access control module 112 is configured to set a network prohibited flag to ON for application processes that accessed the transparently encrypted files 132 such that subsequent network communication is controlled by the data transmission control module 113.

The data transmission control module 113 is configured to control network communication based on process information and a file format. For example, for the transparently encrypted files 132, the data transmission control module 113 allows only data transmission using a predetermined communication protocol. An example of the predetermined communication protocol is Server Message Block (SMB).

The data transmission control module 113 is capable of allowing transmission of the transparently encrypted files 132 to the file sharing server 102 by allowing data transmission when the communication protocol is SMB, and prohibiting transmission of the transparently encrypted files 132 to the C&C server 104 by another communication protocol.

The data transmission control module 113 is also configured to allow data transmission for the non-transparently encrypted files 133 regardless of the communication protocol. Because the non-transparently encrypted files 133 are files that can only be referred to by a user who has input the correct password (for example, the user who is currently logged on to the operating system (OS) of the client 101), the probability of information on the non-transparently encrypted files 133 being leaked even if transmitted to the C&C server 104 is very low. The processing performed by the data loss prevention system according to this embodiment does not depend on the OS.

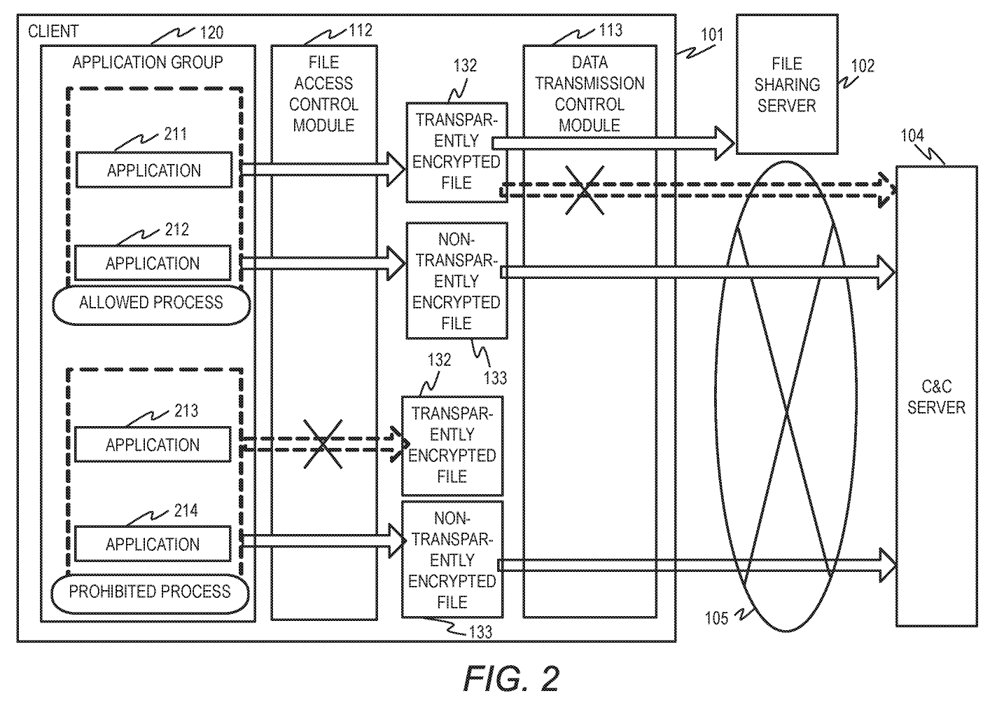

FIG. 3 is a table for showing an example of the process list 117. The process list 117 includes, for example, a handle column 301, an allowed process flag column 302, and a network prohibited flag column 303. The handle column 301 is for storing information indicating a process handle of the processes that are activated on the client 101.

The allowed process flag column 302 is for storing an allowed process flag indicating whether or not the transparently encrypted files 132 are allowed to be accessed by the corresponding process. Processes having the allowed process flag set to ON are allowed to access the transparently encrypted files 132, and processes having the allowed process flag set to OFF are not allowed to access the transparently encrypted files 132.

The network prohibited flag column 303 is for storing a network prohibited flag indicating whether or not communication is allowed to and from an external server via the Internet 105 by the corresponding process. Processes having the network prohibited flag set to ON are prohibited from communicating to and from the external server via the Internet 105, and processes having the network prohibited flag set to OFF are allowed to communicate to and from the external server via the Internet 105. The information stored in the process list 117 is hereinafter also referred to as “process information”.

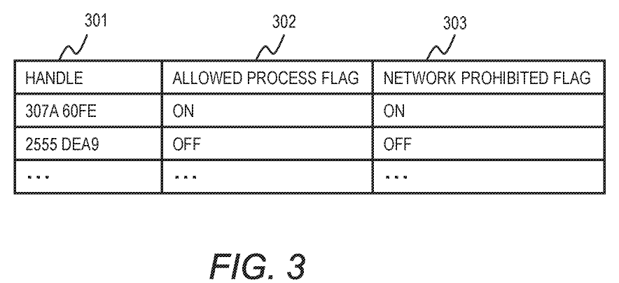

FIG. 4 is a flowchart for illustrating an example of process activation processing. For example, execution of an application on the client 101 triggers the processing illustrated in the flowchart to be started. The process list generation module 118 waits for activation of a process (S401). When a process has been activated, the process list generation module 118 executes the processing from Step S402 and onward for the activated process.

The process list generation module 118 judges whether or not the client 101 is logged on to the OS (S402). When judging that the client 101 is logged on to the OS (S402: TRUE), the process list generation module 118 acquires information on the execution module (for example, an executable file such as an .exe file) corresponding to the process (S403). A hash of the execution module, a path of the execution module, and a presence/absence of a signature corresponding to the execution module, for example, are each an example of information on the execution module. In Step S403, the process list generation module 118 also acquires information indicating whether or not a remote thread has been activated in that process by another process. When judging that the client 101 is not logged on to the OS (S402: FALSE), the process list generation module 118 advances the processing to Step S406, which is described later.

Next, after Step S403, the process list generation module 118 judges whether or not information on the acquired execution module is registered in the white list 114, namely, whether or not the application being executed is registered in the white list 114 (S404).

When judging that the application is not registered in the white list 114 (S404: FALSE), the process list generation module 118 advances the processing to Step S406, which is described later. When judging that the application is registered in the white list 114 (S404: TRUE), the process list generation module 118 determines that the value for the allowed process flag of the process being executed is to be set to ON (S405). Then, the process list generation module 118 restarts activation of the process (S406).

Next, the process list generation module 118 acquires the handle of the activated process, and stores the acquired handle in the handle column 301 (S407). Then, the process list generation module 118 stores the allowed process flag in the cell corresponding to the handle of the activated process in the allowed process flag column 302 (S408). When the processing of Step S405 has been executed, the process list generation module 118 stores “ON” as the value in the cell, and when the processing of Step S405 has not been executed, the process list generation module 118 stores “OFF” as the value in the cell.

Through the processing described above, access to the transparently encrypted files 132 by an activated process corresponding to an application registered in the white list 114 is allowed, and access to the transparently encrypted files 132 by an activated process corresponding to an application not registered in the white list 114 is prohibited. When it is judged in Step S402 that the client 101 is not logged on to the OS, access to the transparently encrypted files 132 by the activated process is prohibited regardless of whether or not the application is registered in the white list 114.

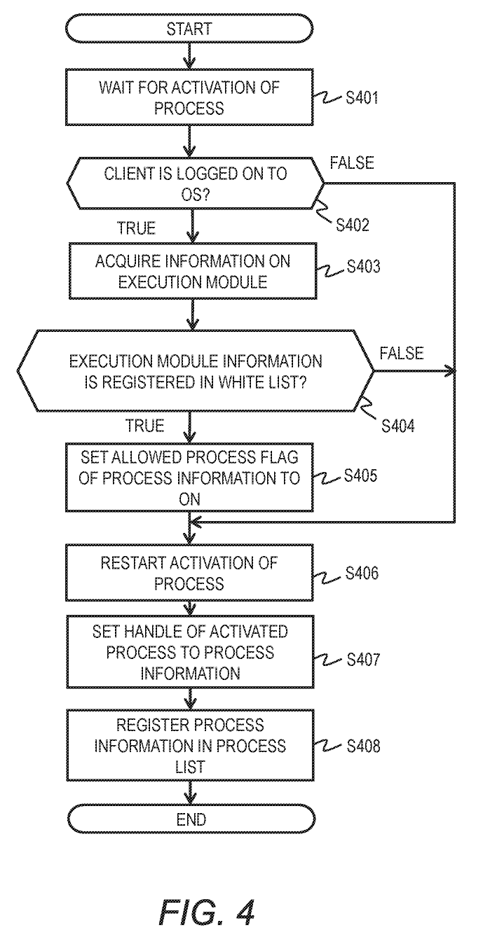

FIG. 5 is a flowchart for illustrating an example of the processing performed when logging on to the OS. Logging on to the OS by the client 101 triggers the processing illustrated in the flowchart to be started. First, the process list generation module 118 retrieves the activated processes from the process list 117 (S501). The process list generation module 118 executes the processing of Steps S503 to S506 for each activated process retrieved in Step S501 (S502), and when that processing has been executed on all the processes, ends the processing of the flowchart of FIG. 5.

The process list generation module 118 acquires information on the execution module corresponding to each process (S503) in the same manner as in Steps S403 to S404, and judges whether or not the acquired information on each execution module is registered in the white list 114, namely, whether or not the application being executed is registered in the white list 114 (S504). In Step S503, the process list generation module 118 also acquires information indicating whether or not, in each process, a remote thread has been activated by another process.

When judging that the application is not registered in the white list 114 (S504: FALSE), the process list generation module 118 advances the processing to Step S506, which is described later. When judging that the application is registered in the white list 114 (S504: TRUE), the process list generation module 118 determines that the value for the allowed process flag of that process is to be set to ON (S505).

Next, the process list generation module 118 updates the cell value corresponding to the handle of the process of the allowed process flag column 302 (S506). When the processing of Step S505 has been executed, the process list generation module 118 stores “ON” as the value in the cell, and when the processing of Step S505 has not been executed, the process list generation module 118 stores “OFF” as the value in the cell.

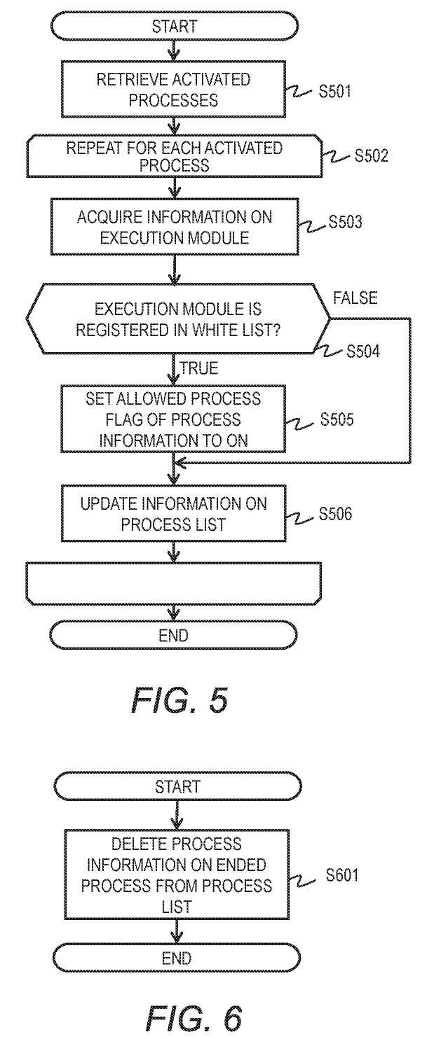

FIG. 6 is a flowchart for illustrating an example of the processing performed when a process has ended. The process list generation module 118 deletes from the process list 117 a record corresponding to the ended process (S601).

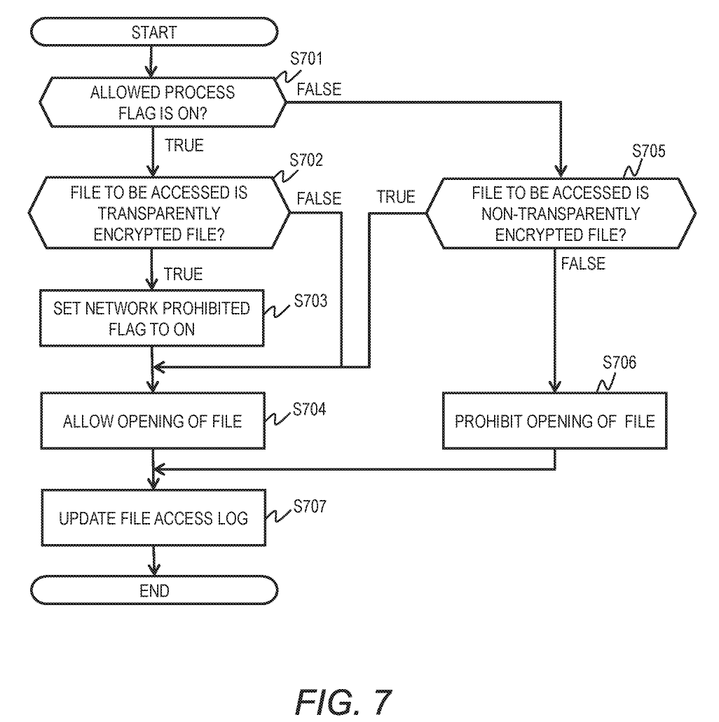

FIG. 7 is a flowchart for illustrating an example of file access control processing. When a process registered in the process list 117 requests opening of a file, the file access control module 112 executes the following processing.

First, the file access control module 112 acquires the allowed process flag of the process from the allowed process flag column 302, and judges whether or not the acquired allowed process flag is ON (S701). When judging that the allowed process flag is ON (S701: TRUE), the file access control module 112 judges whether or not the file to be accessed by the process is a transparently encrypted file 132 (S702).

When judging that the file to be accessed by the process is not a transparently encrypted file 132 (S702: FALSE), the file access control module 112 advances the processing to Step S704, which is described later.

When judging that the file to be accessed by the process is a transparently encrypted file 132 (S702: TRUE), the file access control module 112 determines that the network prohibited flag corresponding to the process is to be set to ON, and reflects that determination in the network prohibited flag column 303 (S703). Then, the file access control module 112 allows opening of the file to be accessed by the process (S704), records in the file access log 115 the fact that there has been a file access by the process (S707), and ends the processing of the flowchart of FIG. 7. The content recorded in the file access log 115 is the same as described above.

When judging that the allowed process flag is not ON (S701: FALSE), the file access control module 112 judges whether or not the file to be accessed by the process is a non-transparently encrypted file 133 (S705). When judging that the file to be accessed by the process is a non-transparently encrypted file 133 (S705: TRUE), the file access control module 112 advances the processing to Step S704.

When judging that the file to be accessed by the process is not a non-transparently encrypted file 133 (S705: FALSE), the file access control module 112 prohibits opening of the file to be accessed by the process (S706), advances the processing to Step S707, and then ends the processing of the flowchart of FIG. 7.

Through the processing of Step S703, the file access control module 112 can prohibit network communication by a process that accessed a transparently encrypted file 132. Through the processing of Steps S705 and S706, the allowed process flag for malware or a similar process is OFF, and hence the file access control module 112 can prohibit access to a transparently encrypted file 132 by the malware.

Through the processing of Steps S704 and S705, the file access control module 112 can access a non-transparently encrypted file 133 even for a process that is not registered in the white list 114. Therefore, through the processing of FIG. 7, file access convenience can be achieved with a high security level.

When judging in Step S701, for example, that the allowed process flag is not ON, the file access control module 112 may skip Step S705, and advance the processing to Step S706. This enables the file access control module 112 to further improve the security level.

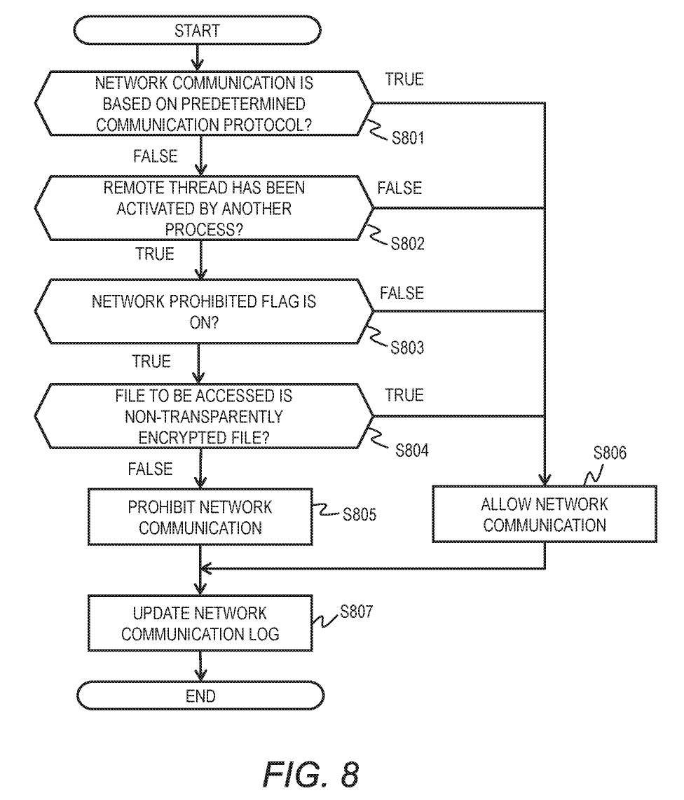

FIG. 8 is a flowchart for illustrating an example of data transmission control processing. The data transmission control module 113 is configured to execute the following processing when a process registered in the process list 117 requests network communication.

First, the data transmission control module 113 judges whether or not network communication requested by the process is based on a predetermined protocol (S801). When judging that the network communication requested by the process is based on the predetermined protocol (S801: TRUE), the data transmission control module 113 allows the network communication by that process (S806). As described above, for example, when the predetermined protocol is SMB, the data transmission control module 113 can enable access to the file sharing server 102 on a local network by the process.

After the processing of Step S806 has been executed, the data transmission control module 113 records in the network communication log 116 the fact that there has been network communication by the process (S807), and ends the processing of the flowchart of FIG. 8. The content recorded in the network communication log 116 is the same as described above.

When judging that the network communication requested by the process is not based on the predetermined protocol (S801: FALSE), the data transmission control module 113 judges whether or not a remote thread has been activated in that process by another process (S802). A thread is an example of a CPU usage unit, and one or more threads form a process. Through the judgment processing of Step S802, the data transmission control module 113 can prohibit network communication by a process that has executed a code injection attack.

When judging that a remote thread has not been activated in the process by another process (S802: FALSE), the data transmission control module 113 advances the processing to Step S806. When judging that a remote thread has been activated in the process by another process (S802: TRUE), the data transmission control module 113 refers to the network prohibited flag column 303 and judges whether or not the network prohibited flag of the process that requested network communication is ON (Step S803).

When judging that the network prohibited flag of the process is not ON (S803: FALSE), the data transmission control module 113 advances the processing to Step S806. When judging that the network prohibited flag of the process is ON (S803: TRUE), the data transmission control module 113 judges whether or not the file to be accessed based on the network communication request by the process is a non-transparently encrypted file 133 (S804).

When judging that the file to be accessed based on the network communication request by the process is a non-transparently encrypted file 133 (S804: TRUE), the data transmission control module 113 advances the processing to Step S806. When judging that the file to be accessed based on the network communication request by the process is not a non-transparently encrypted file 133 (S804: FALSE), the data transmission control module 113 prohibits the network communication by the process (S805), advances the processing to Step S807, and ends the processing of the flowchart of FIG. 8.

Through the processing of Step S804, the data transmission control module 113 can allow data transmission of the non-transparently encrypted file 133. Because the non-transparently encrypted file 133 cannot be referred to by persons other than a legitimate user, by allowing network communication when the file to be accessed is a non-transparently encrypted file 133, the data transmission control module 113 can allow data transmission by a legitimate application such as a mailer or a browser without causing a decrease in the security level. Specifically, convenience can be ensured without causing a decrease in the security level.

The data transmission control module 113 may be configured to not execute at least one of the judgment processes performed in Steps S801, S802, and S804. When more of those judgment processes are executed, the security level becomes higher. However, when fewer of those judgment processes are executed, operability is improved. Therefore, it is desired that the number of judgment processes be determined by the administrator of the client 101 in consideration of a balance between the security level and the operability.

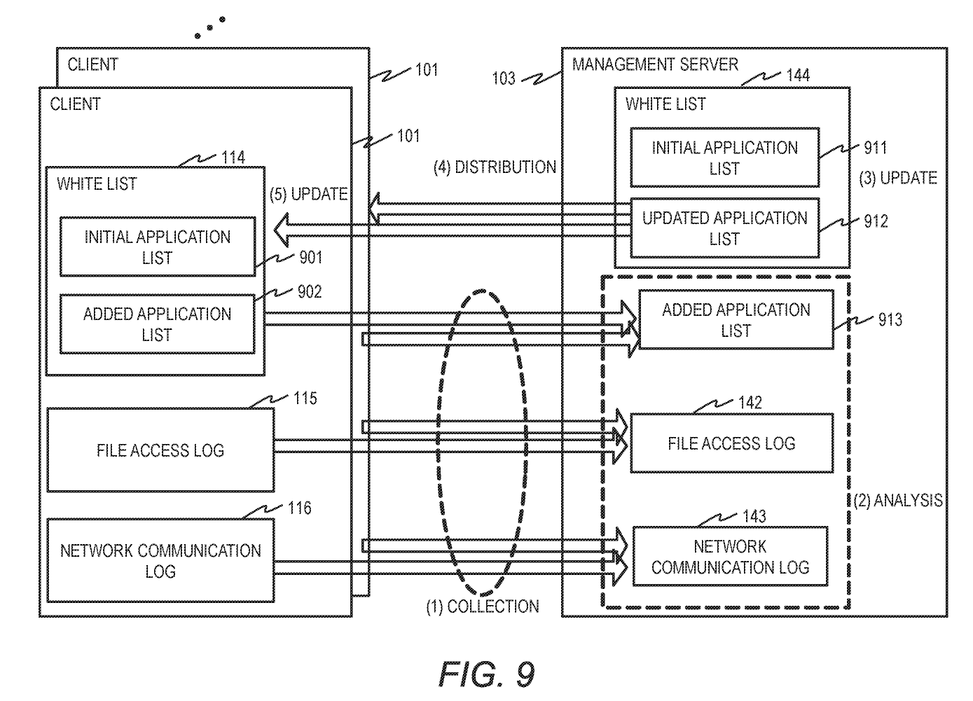

FIG. 9 is an explanatory diagram for illustrating an example of white list update processing. In FIG. 9, there is illustrated an example in which an update application list is created in accordance with information collected by the management server 103 from a plurality of clients 101, the created update application list is distributed to the plurality of clients 101, and the white list 114 is updated by each of the plurality of clients 101 in accordance with the update application list.

The white list 114 includes, for example, two types of white lists, namely, an initial application list 901 and an added application list 902. The initial application list 901 is set in advance when installing the data loss prevention module 111 in the client 101, for example. The added application list 902, which is a white list including applications added by the user of the client 101, is updated as needed.

The white list 144 stored in the management server 103 includes, for example, two types of white lists, namely, an initial application list 911 and an updated application list 912. The initial application list 911 may be, for example, the same white list as the initial application list 901. The updated application list 912 is generated based on information collected from each client 101 by the white list update module 141 of the management server 103, and is for holding information on applications to be added to the white list 114 and information on applications to be deleted from the white list 114.

The white list update module 119 of the client 101 is configured to transmit the added application list 902 to the management server 103, for example, periodically or based on a request from the management server 103. The white list update module 141 of the management server 103 is configured to reflect in an added application list 913 the content recorded in the added application list received from each client 101.

The file access control module 112 is configured to transmit the file access log 115 to the management server 103, for example, periodically or based on a request from the management server 103. The white list update module 141 of the management server 103 is configured to reflect in the file access log 142 the content recorded in the file access log received from each client 101. For example, the file access control module 112 may also be configured to transmit to the management server 103, among the content recorded in the file access log 115, only information indicating whether or not file access by the processes of each application is allowed or prohibited.

The data transmission control module 113 is configured to transmit the network communication log 116 to the management server 103, for example, periodically or based on a request from the management server 103. The white list update module 141 of the management server 103 is configured to reflect in the network communication log 143 the content recorded in the network communication log received from each client 101. For example, the data transmission control module 113 may also be configured to transmit, among the content recorded in the network communication log 116, only information indicating whether or not network communication by the processes of each application is allowed or prohibited to the management server 103.

The white list update module 141 of the management server 103 is configured to generate the updated application list 912 by analyzing the added application list 913, the file access log 142, and the network communication log 143, and to distribute the generated update application list 912 to each client 101.

The white list update module 119 of each client 101 is configured to add to the white list 114 the applications to be added and deleted from the white list 114 the applications to be deleted indicated by the distributed update application list.

The white list update module 119 is configured to add to the initial application list 901 or the added application list 902 the applications to be added. The white list 114 may also include a different application list from the initial application list 901 and the added application list 902, and the white list update module 119 may be configured to add the applications to be added to that application list.

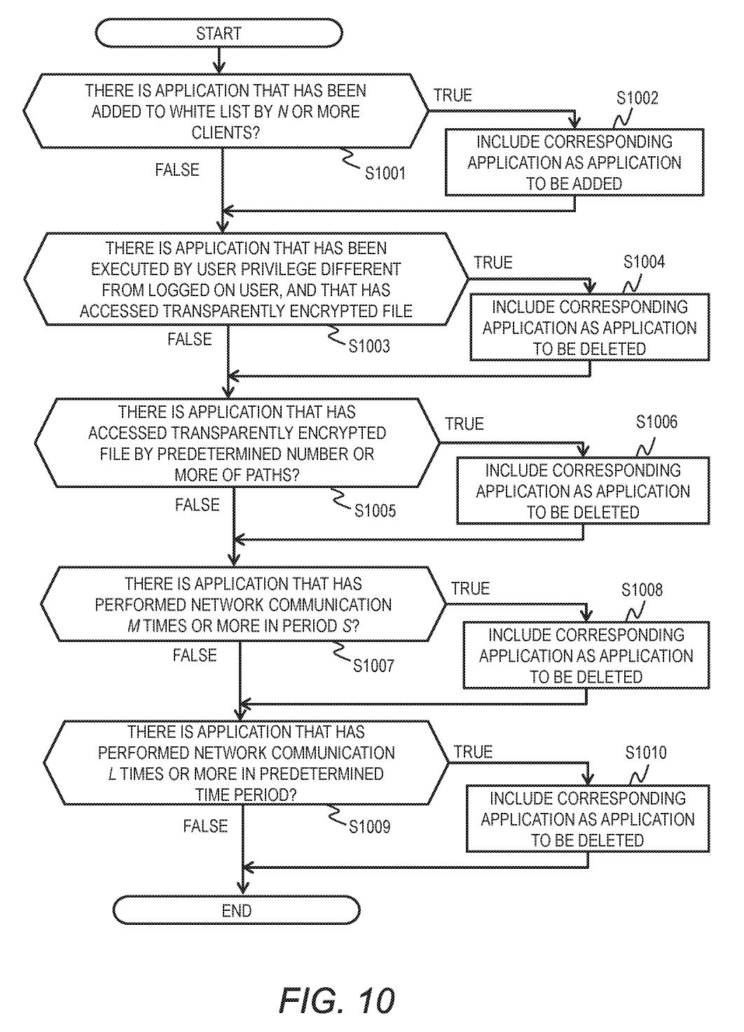

FIG. 10 is a flowchart for illustrating an example of processing of generating the updated application list 912 by the management server 103. The white list update module 141 is configured to start the processing of generating the updated application list 912 periodically or in accordance with an instruction by the user, for example. Of the processing performed by the combination of Steps S1001 and S1002, the combination of Steps S1003 and S1004, the combination of Steps S1005 and S1006, the combination of Steps S1007 and S1008, and the combination of Steps S1009 and S1010, the processing performed by at least one of those combinations may be omitted.

The white list update module 141 refers to the added application list 913, and judges whether or not there is an application that has been added to the added application list 902 by a predetermined number or more of the clients 101 (S1001). When judging that there is such an added application (S1001: TRUE), the white list update module 141 includes that application in the applications to be added of the updated application list 912, and advances the processing to Step S1003.

When judging that there is no such application (S1001: FALSE), the white list update module 141 advances the processing to Step S1003. Execution of the processing of Steps S1001 and S1002 enables the white list update module 141 to add applications that have been judged as being safe by the users of many clients 101 to the white list 114 of another client 101.

Next, the white list update module 141 refers to the file access log 142, and judges whether or not there is an application that has been executed based on a user privilege different from the logged on user, and that has accessed a transparently encrypted file 132 (S1003). When judging that there is such an application (S1003: TRUE), the white list update module 141 includes that application in the applications to be deleted of the updated application list 912 (S1004), and advances the processing to Step S1005.

When judging that there is no such application (S1003: FALSE), the white list update module 141 advances the processing to Step S1005. Execution of the processing of Steps S1003 and S1004 enables the white list update module 141 to delete from the white list 114 suspicious applications that have been executed based on a user privilege different from the logged on user.

Next, the white list update module 141 refers to the file access log 142, and judges whether or not there is an application that has accessed the transparently encrypted file 132 by a predetermined number of paths or more (S1005). When judging that there is such an application (S1005: TRUE), the white list update module 141 includes that application in the applications to be deleted of the updated application list 912 (S1006), and advances the processing to Step S1007. When judging that there is no such application (S1005: FALSE), the white list update module 141 advances the processing to Step S1007.

Execution of the processing of Steps S1005 and S1006 enables the white list update module 141 to delete from the white list 114 suspicious applications that have requested access to files by various paths. For the judgment condition employed in the processing of each of Steps S1003 and S1005, the term “transparently encrypted file” may be replaced with a term “transparently encrypted file and non-transparently encrypted file”.

Next, the white list update module 141 refers to the network communication log 143, and judges whether or not there is an application that has performed network communication M times or more in a period S (S1007). When judging that there is such an application (S1007: TRUE), the white list update module 141 includes that application in the applications to be deleted of the updated application list 912 (S1008), and advances the processing to Step S1009.

When judging that there is no such application (S1007: FALSE), the white list update module 141 advances the processing to Step S1009. Execution of the processing of Steps S1007 and S1008 enables the white list update module 141 to delete, from the white list 114, suspicious applications that have frequently tried to transmit files to the outside.

Next, the white list update module 141 judges whether or not there is an application that has performed network communication L times or more in a predetermined time period by referring to the network communication log 143 (S1009). For example, when the predetermined time period is from 0:00 a.m. to 6:00 a.m., the white list update module 141 determines that an application having even one day in which network communication was performed L times or more during the period from 0:00 a.m. to 6:00 a.m. satisfies the judgment condition of Step S1009. The white list update module 141 may also determine that an application whose average of the number of times that network communication was performed from 0:00 a.m. to 6:00 a.m. for each day of a predetermined duration (for example, one month) is L times or more satisfies the judgment condition of Step S1009.

When judging that there is such an application (S1009: TRUE), the white list update module 141 includes that application in the applications to be deleted of the updated application list 912 (S1010), and ends the processing of the flowchart of FIG. 10. When judging that there is no such application (S1009: FALSE), the white list update module 141 ends the processing of the flowchart of FIG. 10. Execution of the processing of Steps S1009 and S1010 enables, for example, the white list update module 141 to delete from the white list 114 an application that has frequently performed network communication in a suspicious time period during which operations of the client 101 are not normally executed.

As described above, the data loss prevention module 111 according to this embodiment is configured to dynamically change file access control and data transmission control based on whether or not an application process is an allowed process, and whether or not the file to be accessed by the process is a transparently encrypted file 132. As a result, the data loss prevention module 111 is capable of preventing data loss and ensuring further convenience for the user of the client 101, even at a stage when it cannot be detected that the client 101 is infected with malware.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings shows control lines and information lines as considered necessary for explanations but do not show all control lines or information lines in the products. It can be considered that almost of all components are actually interconnected.

What is claimed is:

1. A data loss prevention system which is configured to control network communication and to control access to a file by a process, the data loss prevention system comprising:
a processor; and
a storage device,
the storage device being configured to hold:
a first file, which is one of an unencrypted file and a file that is automatically decryptable by the processor;
a second file, which is not automatically decryptable by the processor; and
process information indicating an allowed process that is allowed to access a file held by the storage device,
the processor being configured to:
receive a file access request by the process;
judge whether or not the process is the allowed process by referring to the process information;
execute judgment processing for judging whether or not network communication by the process is to be prohibited; and
prohibit the network communication by the process when it is judged in the judgment processing that the process is the allowed process and that a file to be accessed in the file access request is the first file.

2. The data loss prevention system according to claim 1, wherein the processor is configured to allow the network communication by the process regardless of a judgment result of the judgment processing when it is judged that the file to be accessed in the file access request is the second file.

3. The data loss prevention system according to claim 1, wherein the processor is configured to allow access to the second file by the process regardless of whether or not the process is the allowed process when it is judged that the file to be accessed in the file access request is the second file.

4. The data loss prevention system according to claim 1, wherein the processor is configured to:
receive a network communication request by the process; and
allow the network communication by the process regardless of a judgment result of the judgment processing when a communication protocol in the network communication request is a predetermined communication protocol.

5. The data loss prevention system according to claim 1, wherein the processor is configured to allow the network communication by the process regardless of a judgment result of the judgment processing when it is judged that a remote thread has not been activated in the process by another process.

6. The data loss prevention system according to claim 1, wherein the processor is configured to:
receive a designation of an application from a plurality of users; and
add as the allowed process to the process information a process of an application designated by a predetermined number or more of the plurality of users.

7. The data loss prevention system according to claim 1,
wherein the storage device is further configured to hold a file access log indicating an access history of a file held by the storage device by an application,
wherein the file access log indicates a user privilege that executed the application, and
wherein the processor is configured to:
acquire the user privilege from the file access log; and
change an allowed process in the process information based on a comparison result between the acquired user privilege and a user logged on to the data loss prevention system.

8. The data loss prevention system according to claim 1,
wherein the storage device is further configured to hold a file access log indicating an access history of a file held by the storage device by an application,
wherein the file access log indicates a number of paths of a file accessed by the application, and
wherein the processor is configured to:
acquire the number of paths from the file access log; and
change an allowed process in the process information based on the acquired number of paths.

9. The data loss prevention system according to claim 1,
wherein the storage device is further configured to hold a network communication log indicating a number of times of network communication performed by an application, and
wherein the processor is configured to:
acquire the number of times of network communication from the network communication log; and
change an allowed process in the process information based on the acquired number of times of network communication.

10. A data loss prevention method by a data loss prevention system being configured to control network communication and to control access to a file by a process,
the data loss prevention system being configured to hold:
a first file, which is one of an unencrypted file and a file that is automatically decryptable by the data loss prevention system;
a second file, which is not automatically decryptable by the data loss prevention system; and
process information indicating an allowed process that is allowed to access a file held by the data loss prevention system,
the data loss prevention methods comprising:
receiving, by the data loss prevention system, a file access request by the process;
judging, by the data loss prevention system, whether or not the process is the allowed process by referring to the process information;
executing, by the data loss prevention system, judgment processing for judging whether or not network communication by the process is to be prohibited; and
prohibiting, by the data loss prevention system, the network communication by the process when it is judged in the judgment processing that the process is the allowed process and that a file to be accessed in the file access request is the first file.
